(19) United States
(12) Patent Application Publication
(10) Pub. No.: US 2019/0333022 A1
(43) Pub. Date: Oct. 31, 2019

(54) SCHEDULE CONTROL SYSTEM BASED ON INCREMENTAL TIME RECOVERY USING SCHEDULING ASSISTANCE LOGIC

(71) Applicant: Microsoft Technology Licensing, LLC, Redmond, WA (US)

(72) Inventors: Charles Yin-Che LEE, Bellevue, WA (US); Pamela BHATTACHARYA, Redmond, WA (US); Mayerber LOUREIRO DE CARVALHO NETO, Kirkland, WA (US); Warren JOHNSON, Sammamish, WA (US); Juliana Pena OCAMPO, Redmond, WA (US); Chala FUFA, Redmond, WA (US); Benjamin Gene CHEUNG, Redmond, WA (US); Shahil SONI, Seattle, WA (US)

(21) Appl. No.: 15/966,648

(22) Filed: Apr. 30, 2018

(51) Int. Cl. G06Q 10/10

(52) U.S. Cl. CPC G06Q 10/1095; H04L 51/046

(57) ABSTRACT

A time aggregation and control system detects when an automated scheduling assistant is invoked to perform a scheduling operation. It detects scheduling characteristics corresponding to the scheduling operation and identifies a time saving value corresponding to the scheduling operation. The time saving value is aggregated over a plurality of different scheduling operations until a time block trigger is detected. A scheduling control signal is generated, to automatically reserve a block of time, based upon the aggregated time saving values.

### BACKGROUND

Computing systems are currently in wide use. Some computing systems include scheduling or calendar computing systems that expose scheduling functionality that allows a user to perform scheduling operations. This type of functionality allows a user to schedule appointments, schedule meetings, lock or otherwise reserve blocks of time so that no meetings or conference calls can be scheduled during that time, among a wide variety of other things.

Such computing systems also often include electronic mail (e-mail) systems. E-mail systems expose e-mail functionality that allows a user to perform e-mail operations, such as authoring, sending and reading e-mail messages, sending and receiving attachments, configuring folders, etc. The e-mail system and scheduling system can be part of the same system, or they can be two separate systems that interact with one another.

Some current scheduling systems also have a set of assistance logic that operates to assist a user in scheduling a meeting. The assistance logic can, for instance, be used to view the calendars of different attendees in such a way that blocks of free time, for all attendees, can be visualized. It can perform other operations, as well.

Even in systems with assistance logic, scheduling a meeting can be quite time intensive. The time it takes to schedule a meeting can vary based on different characteristics of the meeting (such as the number of attendees) and the time can accumulate significantly when a user is tasked with organizing and scheduling multiple different meetings.

The discussion above is merely provided for general background information and is not intended to be used as an aid in determining the scope of the claimed subject matter.

### SUMMARY

A time aggregation and control system detects when an automated scheduling assistant is invoked to perform a scheduling operation. It detects scheduling characteristics corresponding to the scheduling operation and identifies a time saving value corresponding to the scheduling operation. The time saving value is aggregated over a plurality of different scheduling operations until a time block trigger is detected. A scheduling control signal is generated, to automatically reserve a block of time, based upon the aggregated time saving values.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a block diagram showing one example of time aggregation and control logic, in more detail.

FIGS. 3A and 3B (collectively referred to herein as FIG. 3) illustrate a flow diagram showing one example of the operation of the architecture illustrated in FIG. 1 in automatically blocking time based on an aggregated time saving value.

FIG. 4 is a block diagram showing one example of the architecture illustrated in FIG. 1, deployed in a cloud computing architecture.

FIGS. 5-7 show examples of mobile devices that can be used in the architectures shown in the previous figures.

FIG. 8 is a block diagram showing one example of a computing environment that can be used in the architectures shown in the previous figures.

### DETAILED DESCRIPTION

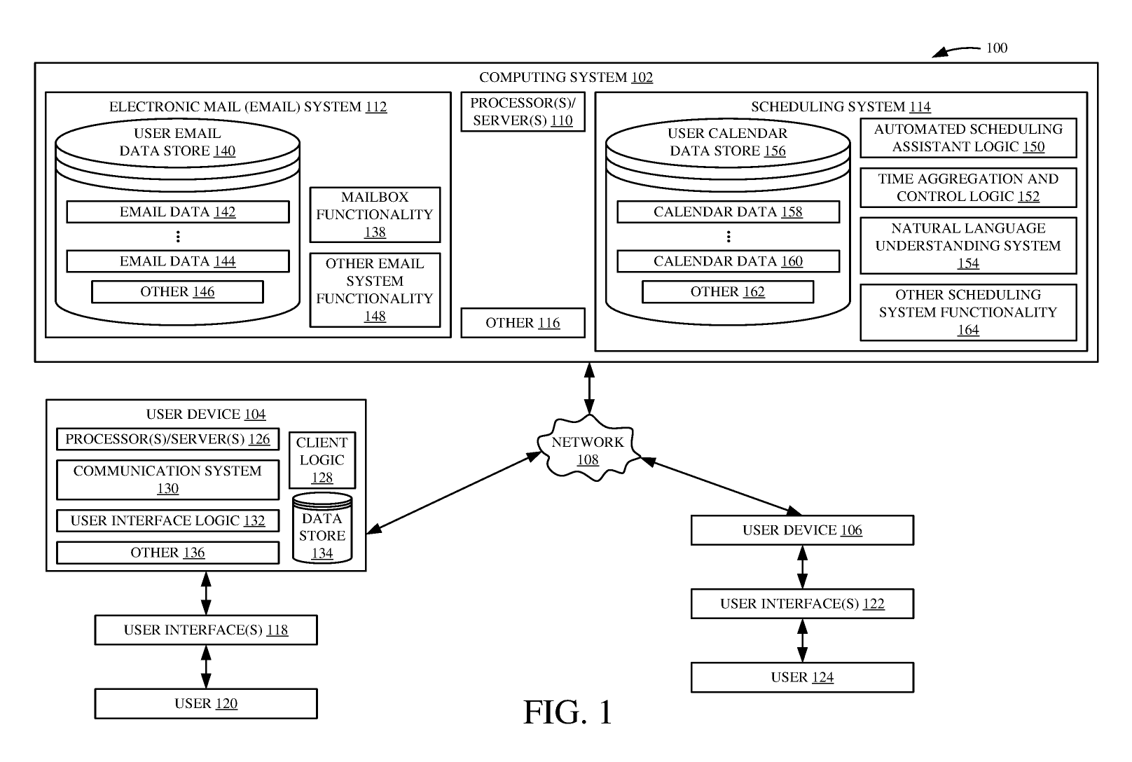

FIG. 1 is a block diagram showing one example of a computing system architecture 100. Architecture 100 shows computing system 102 coupled to a plurality of different user devices 104-106 over network 108. Network 108 can be any of a wide variety of different types of networks, such as a wide area network, a local area network, a near field communication network, a cellular network, or any of a wide variety of other networks or combinations of networks.

In the example illustrated, computing system 102 illustratively hosts an e-mail service and a calendar or scheduling service for access by user devices 104-106. Therefore, in the example shown in FIG. 1, computing system 102 includes one or more processors or servers 110, electronic mail (e-mail) system 112, scheduling system 114, and it can include a wide variety of other items 116. In another example, e-mail system 112 and scheduling system 114 are integrated into a single system. They are shown as separate systems for the sake of example only.

FIG. 1 also shows that user device 104 generates user interfaces 118 for interaction by user 120. Therefore, user 120 illustratively interacts with user interfaces 118 in order to control and manipulate user device 104 and some portions of computing system 102. Similarly, user device 108 illustratively generates user interfaces 122 for interaction by user 124. Therefore, user 124 illustratively interacts with interfaces 122 in order to control and manipulate user device 106 and portions of computing system 102.

User devices 104-106 can be similar or different. For the sake of the present example, it will be assumed that they are similar so that only user device 104 is described in more detail. This is for the sake of example only.

User device 104 illustratively includes one or more processors or servers 126, client logic 128, communication system 130, user interface logic 132, data store 134, and it can include a wide variety of other items 136. Client logic 128 can be a client component of e-mail system 112 or scheduling system 114 or both. In such an example, client logic 128 performs functionality that allows user device 104 to communicate with systems 112 and 114 over network 108. It will be noted, however, that user device 104 need not necessarily have client logic 128, in which case user device 104 communicates directly with computing system 102 where substantially all of the functionality of computing system 102 is hosted on system 102.

Communication system 130 illustratively allows user device 104 to communicate over network 108. Therefore, depending upon the type of network mechanisms that form network 108, communication system 130 will be configured for communication over that type of network.

User interface logic 132 illustratively generates user interfaces 118 and detects user interaction with those interfaces 118. It can provide an indication of the interactions to other items on device 104 and/or to computing system 102 over network 108, using communication system 130.

In the example shown in FIG. 1, e-mail system 112 includes mailbox functionality 138, user e-mail data store 140 (which, itself, includes e-mail data records 142-144 for various users of e-mail system 112, and it can include other items 146), and other e-mail system functionality 148. Mailbox functionality 138 is illustratively functionality that maintains a mailbox for various users 120-124 and allows the users to perform mailbox operations. The mailbox operations can include authoring, sending and receiving e-mail messages, attaching, opening and otherwise processing attachments, configuring filters and folders, among a wide variety of other functionality. Other e-mail system functionality 148 can perform a wide variety of different functions. In one example, it allows users of e-mail system 112 to access scheduling system 114 from within e-mail system 112, and to perform scheduling operations in scheduling system 114.

Scheduling system 114 can include automated scheduling assistant logic 150, time aggregation and control logic 152, natural language understanding system 154, user calendar data store 156 (which stores items of calendar data 158-160 for a number of users and which can include other items 162), and other scheduling system functionality 164. In one example, automated scheduling assistant logic 150 is a conversational virtual scheduling assistant that employs artificial intelligence or other techniques that automatically perform some or all of the operations that user 120 would otherwise perform in order to schedule a meeting with a set of meeting attendees. Logic 150 can be invoked to perform those operations by giving it some directive to broker the scheduling of a meeting among a list of attendees. For instance, user 120 may send an e-mail message to a set of attendees, and also send that e-mail message to an e-mail address corresponding to automated scheduling assistant logic 150. The e-mail message may include some directive that directs logic 150 to broker the scheduling of the meeting among the various people who receive the e-mail message. The directive may be a natural language message such as “Scheduling assistant, please schedule a one hour meeting with this group next week.” Logic 150 then automatically performs the steps of locating times to find availability for the meeting, scheduling the meeting, and notifying attendees.

If logic 150 has access to the calendars of all of the meeting attendees, then logic 150 can automatically identify free times by accessing calendar data 158-160 and confirm that the users can meet during those times. However, if logic 150 does not have access to the calendar of all of the attendees (e.g., if some of the attendees work for another organization, etc.), then logic 150 can perform the operations that are used in order to identify free time for those individuals as well. This may include sending an e-mail to those attendees, inquiring when they are free, sending a ballot message which proposes a plurality of different times and asks the recipients of that message to select the best time for them to meet, or other operations.

Automated scheduling assistant logic 150 can use e-mail system 112 to automatically send e-mails to the various recipients of the meeting to request any additional information that is needed, to automatically send meeting requests or scheduling requests to those recipients, to interact with the calendaring logic to place the items on the calendar of those recipients, or to otherwise interact with the recipients, with user 120, with e-mail system 112 and with the functionality on scheduling system 114.

Time aggregation and control logic 152 illustratively monitors the use of scheduling assistant logic 150, on a per-user basis to identify an amount of time that the user (e.g., user 120) has saved, or could have saved, by using the automated scheduling assistant logic 150. The time required to perform a scheduling operation will differ based on a number of characteristics of the meeting. For instance, it will differ based on the number of attendees expected for the operation, the selection and scheduling of the location for the meeting, the number of conversational turns required to reach consensus amongst attendees of the meeting, the location of the attendees (such as whether they are located in the same time zone or a different time zone), the organization that the attendees work for (e.g., whether the organizer has access to their calendars or needs to find free times by inquiring of the attendees), among other things. Thus, based upon various characteristics indicative of the complexity of the scheduling operation, the time required of an organizer to perform the scheduling operation may be on the order of tens of minutes, as an example.

For instance, assume that user 120 invokes the automated scheduling assistant logic 150 to schedule a relatively complex meeting where there are a number of invitees, in different time zones and in different organizations. Automated scheduling assistant logic 150 can carry out the various operations and communications in order to identify an acceptable meeting time for all invitees and to schedule that meeting time, without further involvement from user 120 except, perhaps, to initiate or authorize the operations performed by logic 150. This can save user 120 a great deal of time, depending upon the number of rounds of communication (e.g., e-mail messages) that were needed to identify a suitable time and location for everyone and to schedule that time and location.

Time aggregation and control logic 150 keeps track of the amount of time saved by user 120 in using automated scheduling assistant logic 150. When logic 154 aggregates a sufficient amount of time that has been saved, then aggregation logic 154 illustratively generates communications to interact with user 120 based on this. For instance, assume that user 120 has saved two hours over the period of a week, by invoking automated scheduling assistant logic 150. In that case, time aggregation and control logic 154 may surface an indication of this to user 120 and propose to user 120 that user 120 reserve two hours the following week as blocked time so that user 120 may focus on any desired activity during that time. The time savings is measured against the time that it would have taken the user to perform the coordination of the meeting, himself or herself. The amount of time saved per individual scheduling request will vary, based on the complexity of the logistics in scheduling the meeting. In one example, logic 154 accumulates the time savings from individual scheduling requests, over an accumulation interval (e.g., on a periodic basis, such as on a weekly basis) and sends and e-mail to inform user 120 of the total amount of time that has been saved throughout that interval, and to offer user 120 an opportunity to lock in an equivalent amount of time the following week, so long as the total savings is larger than some predefined block of time (e.g., so long as the accumulated time is greater than two hours, four hours, one hour, etc.).

In response, user 120 can reply back to the e-mail, using natural language, to affirm his or her consent. In that case, time aggregation and control logic 152 controls automated scheduling assistant logic 150 (or other scheduling logic) to create a calendar event (or scheduling event) to lock in the time identified, the following week, on the calendar of user 120.

In performing the various natural language understanding tasks, natural language understand system 154 can be used. Natural language understanding system 154 can be part of scheduling system 114 or e-mail system 112, or separate from those systems but part of computing system 102. In other examples, natural language understanding system 154 may be a separate system that is accessed by computing system 102 over network 108. All of these and other architectures are contemplated herein.

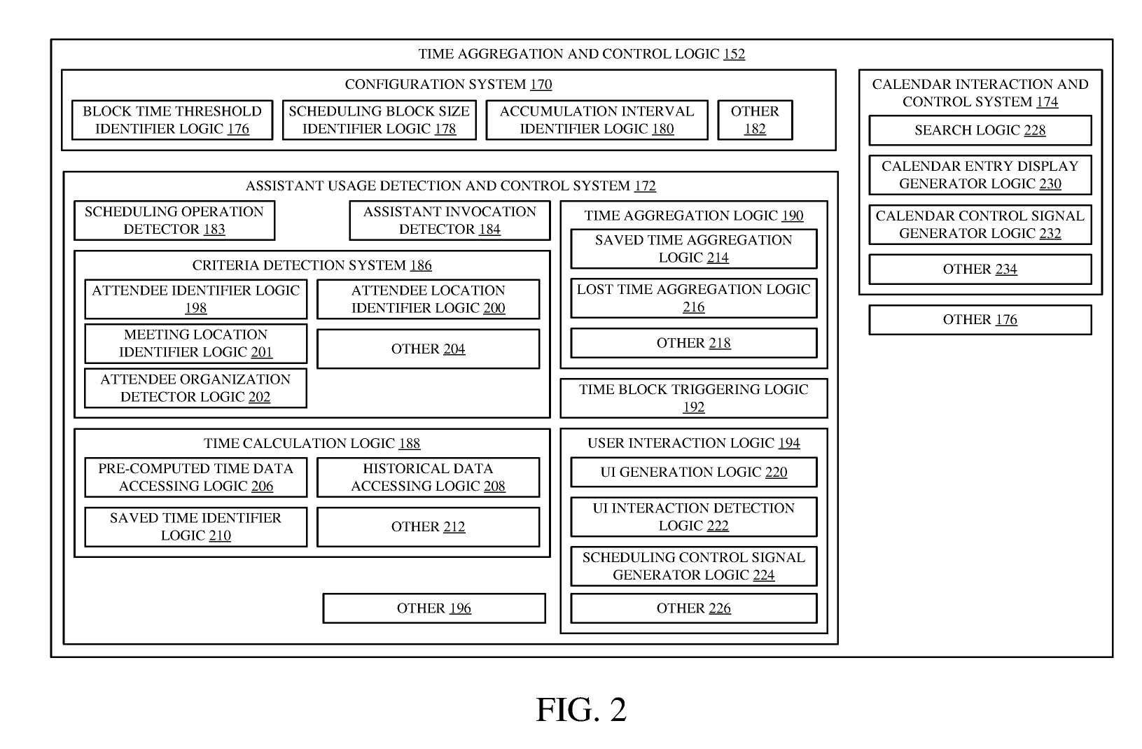

FIG. 2 is a block diagram showing one example of time aggregation and control logic 152, in more detail. In the example shown in FIG. 2, logic 152 includes configuration system 170, assistant usage detection and control system 172, calendar interaction and control system 174, and it can include a wide variety of other items 176. Configuration system 170 includes block time threshold identifier logic 176, scheduling block size identifier logic 178, accumulation interval identifier logic 180, and it can include other items 182.

Assistant usage detection and control system 172 illustratively includes scheduling operation detector 183, assistant invocation detector 184, criteria detection system 186, time calculation logic 188, time aggregation logic 190, time block triggering logic 192, user interaction logic 194, and it can include other items 196. Criteria detection system 186 illustratively includes attendee identifier logic 198, attendee location identifier logic 200, meeting location identifier logic 201, attendee organization detector logic 202 and it can include other items 204. Time calculation logic 188 illustratively includes pre-computed time data accessing logic 206, historical data accessing logic 208, saved time identifier logic 210, and it can include other items 212. Time aggregation logic 190 illustratively includes saved time aggregation logic 214, lost time aggregation logic 216, and it can include other items 218. User interaction logic 194 illustratively includes user interface (UI) generation logic 220, UI interaction detection logic 222, scheduling control signal generator logic 224, and it can include other items 226. Calendar interaction and control system 174 illustratively includes search logic 228, calendar entry display generator logic 230, calendar control signal generator logic 232, and it can include other items 234. Before describing the overall operation of time aggregation and control logic 152 in more detail, a brief overview of some of the items in logic 152, and their operation, will first be provided.

Configuration system 170 illustratively obtains configuration information which influences some aspects of the operation of time aggregation and control logic 152. For instance, block time threshold identifier logic 176 obtains threshold information that is indicative of the threshold size of block time that will be scheduled based on the time saved using the automated scheduling assistant logic 150. By way of example, it may be that the user is not prompted to reserve any time the following week until the aggregated saved time reaches the threshold block time of two hours. Block time threshold identifier logic 176 can obtain this threshold value in a variety of different ways. For instance, logic 176 can use e-mail system 112 to conduct a dialogue with user 120 asking the user 120 to specify the threshold time. In another example, block time threshold identifier logic 176 can obtain a default value, or a dynamically changing value, based upon the work habits of user 120 or based on other criteria.

Scheduling block size identifier logic 178 identifies a preferred block size for which reserved time can be scheduled. By way of example, assume that user 120 has accumulated eight hours of saved time, by using the automated scheduling assistant logic 150. However, it may be that user 120 does not wish to reserve all eight hours on the same day. Instead, the user may wish to reserve four blocks, of two hours each. Alternatively, the user may wish to reserve time in four hour blocks. Logic 178 obtains this scheduling block size, and can do so in a number of ways. For instance, as with logic 176, logic 178 can conduct a dialogue with user 120 to identify the preferences of user 120. Logic 178 can also obtain a default scheduling block size, or it can obtain the scheduling block size in a dynamic way as well.

Accumulation interval identifier logic 180 identifies the accumulation interval over which saved time will be aggregated (or accumulated) before it is reported to, or surfaced to, user 120. In one example, this can be a periodic, temporal interval (such as every week, every two weeks, every month, etc.). In another example, it can be intermittent and based on the amount of aggregated time. The accumulation interval may be used in a variety of different ways, as is discussed in greater detail below. Accumulation interval identifier logic 180, as with logic 176 and logic 178, can obtain accumulation interval information indicative of the accumulation interval in a wide variety of different ways. For instance, it can obtain the information by interacting with user 120 to identify the preferences of user 120 for the accumulation interval. In another example, it can use a default interval or the interval can be identified dynamically, such as based on the usage characteristics of user 120 or in other ways.

Assistant usage detection and control system 172 detects when user 120 uses (and when user 120 does not use) the automated scheduling assistant logic 150 and identifies the characteristics of the scheduling operation that the user is attempting to schedule using logic 150. Based on those characteristics or criteria, it calculates a time associated with that scheduling operation. The time is an estimate of the time that user 120 would otherwise have taken to schedule the meeting. It aggregates that time over the accumulation interval. If the user used logic 150 to perform the scheduling operation, the time is accumulated as saved time. If the user did not use logic 150 to perform the scheduling operation, the time is accumulated as lost time. When sufficient saved time has been accumulated, it surfaces an indication of that to user 120 and determines whether user 120 wishes to reserve that same amount of time (or a subset of the aggregated time) the following week on the user's calendar (or at another point in the future).

Scheduling operation detector 183 first detects whether user 120 has performed a scheduling operation (such as scheduled a meeting, etc.). Assistant invocation detector 184 detects whether user 120 invoked the automated scheduling assistant logic 150 in order to perform that scheduling operation. It will be noted that, in an example where the lost time (or time that user 120 could have saved, by using logic 150) is not being tracked, then logic 152 simply detects when automated scheduling assistant logic 150 is invoked.

Assistant invocation detector 184 can detect this in a wide variety of different ways. For instance, logic 150 can send detector 184 an invocation signal indicating that logic 150 has been invoked by user 120. It can be detected in other ways as well.

Criteria detection system 186 then detects the various criteria or characteristics of the scheduling operation that has been performed. These characteristics or criteria are those which determine the amount of time that a user 120 would normally take to perform the scheduling operation. Thus, attendee identifier logic 198 can identify the number of attendees and various characteristics of those attendees (such as whether it is historically difficult to schedule meetings with those attendees, and/or other characteristics of the attendees. Attendee location identifier logic 200 identifies the location of the various attendees). For instance, where the attendees are in two widely different time zones, it can be more difficult to identify available times for a meeting, and this can take longer. Thus, the location of the various attendees is identified. Meeting location identifier logic 201 identifies a location (such as a conference room, a virtual room—online meeting/VoIP, etc.) where a meeting is to be located. Securing a conference room is often a time consuming task, and therefore it can influence the time needed to perform a scheduling operation. Attendee organization detector logic 202 identifies whether the attendees are part of the same organization. If they are, then logic 152 will have automated access to their calendars. In this way, free time can be identified without needing to ask the attendees to provide an indication of when they are free. This influences the time needed to perform a scheduling operation.

Once the criteria or characteristics of the scheduling operation have been identified by system 186, time calculation logic 188 calculates a time associated with performing the scheduling operation. In one example, time values can be pre-computed based upon the values for the different meeting characteristics or criteria identified by system 186. Thus, when a particular set of criteria or characteristics are present for a scheduling operation, then pre-computed time data accessing logic 206 can identify the time value associated with scheduling operation based upon the criteria or characteristics. This can be done by filtering various time values based upon the criteria or characteristics of the meeting request, or the pre-computed time values can be identified in other ways as well.

In another example, historical data may be aggregated for user 120, for the various attendees of the meeting, or for a wider group of people. That historical data may indicate how difficult it is to schedule a meeting where the meeting has various characteristics, attendees, or other criteria. Thus, historical data accessing logic 208 can access historical data to identify how difficult it is to schedule a meeting, such as how many conversational rounds are normally used in order to schedule a meeting having the same characteristics or criteria. The time value can be identified in other ways as well.

In another example, a saved time model can be generated, and the model can be used by saved time identifier logic 210 to identify a saved time value. The characteristics or criteria corresponding to the scheduling operation can be applied to the saved time model and the saved time model can then output a saved time value corresponding to that scheduling operation. The saved time model can be configured to change dynamically, using machine learning techniques, as well. Saved time identifier logic 210 can obtain the time value from a saved time model in other ways as well.

Once the time corresponding to the scheduling operation under analysis has been identified by time calculation logic 188, then time aggregation logic 190 aggregates that time with other time values for user 120. If the user 120 invoked automated scheduling assistant logic 150 to perform the scheduling operation under analysis, then saved time aggregation logic 214 aggregates the time value identified by time calculation logic 188 with other time that user 120 has saved by using automated scheduling assistant logic 150, during the accumulation time interval. However, if user 120 did not use automated scheduling assistant logic 150, then lost time aggregation logic 216 aggregates the time value generated by time calculation logic 188 with other lost time that corresponds to scheduling operations that were performed by user 120 without using automated scheduling assistant logic 150, during the accumulation interval.

At some point, time block triggering logic 192 will trigger user interaction logic 194 to surface information regarding aggregated time for user 190. For instance, time block triggering logic 192 can wait for the accumulation interval to pass and this can be used as a trigger to surface saved time, and lost time, for user 120. In another example, when the accumulated saved or lost time values have reached a threshold level, then this may trigger time block triggering logic 192 so that this information can be surfaced for user 120. Time block triggering logic 192 can trigger user interaction logic 194 to surface information about saved or lost time for user 120 in other ways as well.

When user interaction logic 194 is triggered, UI generation logic 220 generates a user interface display that will be surfaced for user 120. When lost time is to be surfaced for user 120, then user interface generation logic 220 may generate a user interface display which shows the various scheduling operations that were performed by user 120, without invoking automated scheduling assistant logic 150. Each of those display items (corresponding to a meeting request that was manually scheduled by user 120) may also have a corresponding lost time value indicator that shows the estimated amount of lost time that user 120 spent in manually performing the scheduling operation and that could have been saved if the user had invoked automated scheduling assistant logic 150.

If user interaction logic 194 is surfacing saved time for user 120, then UI generation logic 220 can generate a similar user interface display, except showing the amount of time that user 120 saved on each scheduling operation, because the user invoked automated scheduling assistant logic 150. The user interface display can also include an accumulated time display item that shows the accumulated amount of saved time, during the current accumulation interval. It can show any hold over time that has not been used by the user from prior accumulation intervals as well. User interface generation logic 220 can generate the user interface with user input mechanisms that prompt user 120 to reserve time, the following week (or at another time in the future) based upon the accumulated, saved time. For instance, the user interface display may show the accumulated amount of saved time and ask the user whether the user wishes to reserve a same amount of time the following week, and provide a user input mechanism that can be actuated by the user to do so.

In one example, UI generation logic 220 generates the user interface display as part of an e-mail message that is sent to user 120. The e-mail message may instruct the user to simply reply affirmatively, in order to reserve the same amount of time the following week. The e-mail message may include other information as well. For instance, if the user has saved six hours, then the user interface display may ask the user to choose a way that the user wishes to reserve that amount of time the following week. For instance, the user interface display may provide options for three two-hour blocks, one four-hour block and one two-hour block or a contiguous six-hour block. These are mentioned by way of example only. In such a scenario, the user can illustratively select one of the options and reply to the e-mail message.

UI interaction detection logic 222 detects any user interactions with the user interface display that is surfaced for user 120. For instance, if the user interface display is surfaced as part of an e-mail message, then UI interaction detection logic 222 may detect that the user has replied to the e-mail message, chosen a time blocking option, or interacted with the e-mail message in other ways.

Based upon the user interactions detected, scheduling control signal generator logic 224 generates control signals to control calendar interaction and control system 174. Calendar interaction and control system 174 can be used to identify free times that are to be blocked off the following week, based upon the user interactions. It will be noted that calendar interaction and control system 174 may be part of automated scheduling assistant logic 150 so that scheduling control signal generator logic 224 generates control signals to control automated scheduling assistant logic 150 to find and block off times the following week. However, calendar interaction and control system 174 is shown separately from automated scheduling assistant logic 150 for the sake of example only.

In the example shown in FIG. 2, scheduling control signal generator logic 224 can generate control signals to control search logic 228 to identify blocks of time that are to be reserved the following week (or at another point in the future) based upon the user interactions. Logic 224 can provide control signals to calendar control signal generator logic 232 which controls the calendar for user 122 to place an entry on that calendar corresponding to the time blocks that are reserved and that were identified as being free times by search logic 228. Calendar entry display generator logic 230 can generate a display that is placed on the user's calendar to identify the time as time that was saved by the user in using automated scheduling assistant logic 150. For instance, the block time can be color-coded, it can have a textual description indicating that this is blocked time that was reserved because the user saved time by using the scheduling assistant, or it can be identified by other visual indicia, or in other ways. Similarly, where the user has accumulated, for instance, six hours of saved time, and the time has been blocked off in three two-hour increments, then the entry on the user's calendar may indicate that this is a first of three, second of the three or third of the three, time blocks that are reserved based upon the amount of accumulated saved time. Calendar entry display generator logic 230 can generate the calendar entry display in a wide variety of other ways as well.

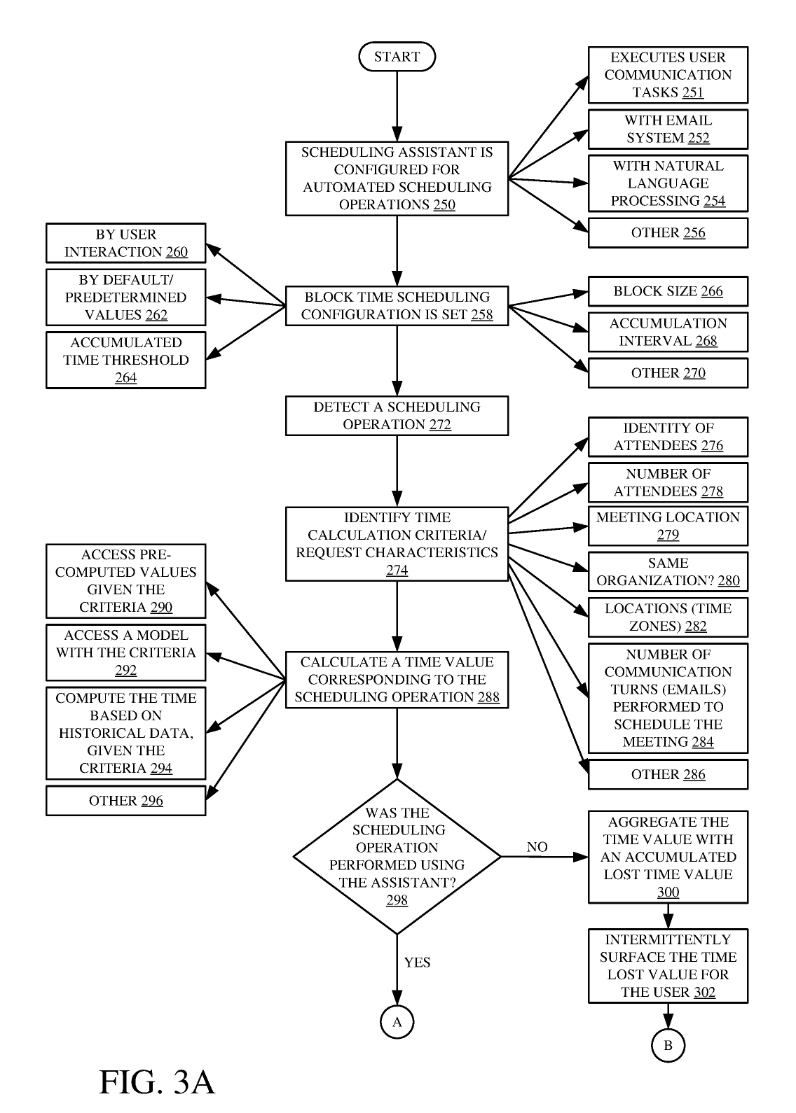

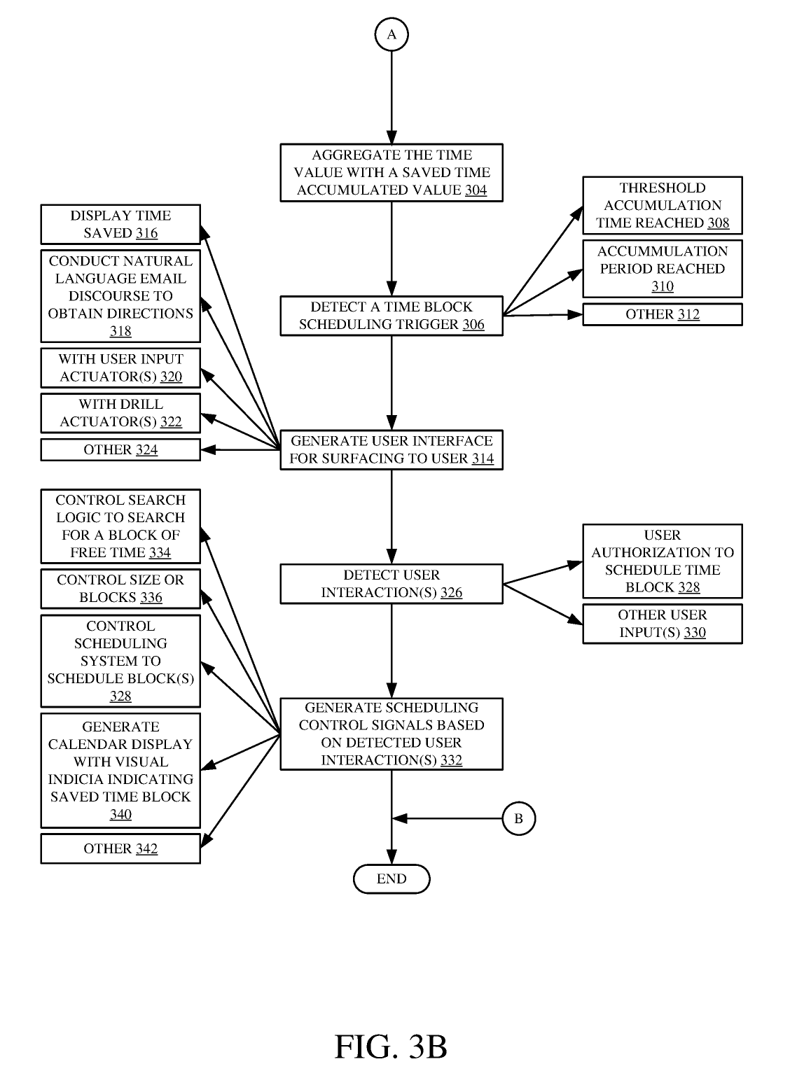

FIGS. 3A and 3B (collectively referred to herein as FIG. 3) show a flow diagram illustrating one example of the operation of architecture 100 (and time aggregation and control logic 152) in identifying saved time and lost time with respect to invoking the use of automated scheduling assistant logic 150, and in automatically reserving time blocks the following week, corresponding to the amount of time saved.

It is first assumed that automated scheduling assistant logic 150 is configured for automated scheduling operations. This is indicated by block 250 in the flow diagram of FIG. 3. It can automatically perform all tasks that include communication with other users (such as author and respond to e-mail messages, etc.). This is indicated by block 257. By automatically, it is meant that the operation is performed without any further user involvement except, perhaps, to initiate or authorize the operation. In one example, it can perform those operations using e-mail system 112. This is indicated by block 252. By way of example, it can communicate with potential attendees of a meeting by e-mail, it can be invoked by e-mail, and it can perform other operations (such as disambiguating meeting times, etc.) by conducting dialogue through e-mail. Some of this is described above.

In another example, the automated scheduling assistant logic 150 is based on conversational artificial intelligence mechanisms that use natural language understanding system 154 to conduct natural language communications. Using natural language processing to perform the automated scheduling operations is indicated by block 254. Automated scheduling assistant logic 150 can be configured to perform automated scheduling operations in other ways as well, such as to automatically identify free time, schedule meetings during that time, etc., and to perform other operations as well. This is indicated by block 256.

It is also assumed that configuration system 170 has identified the various configuration information that it uses to configure time aggregation and control logic 152. This is indicated by block 258. This can be done in a wide variety of ways, as discussed above. For instance, it can be done based on user inputs or by other user interaction. This is indicated by block 260. It can be done by obtaining default or other predetermined values. This is indicated by block 262. The configuration information can include an accumulated time block threshold that is identified by block time threshold identifier logic 176. This is indicated by block 264. It can include block size configuration information as identified by scheduling block size identifier logic 178. This is indicated by block 266. It can include accumulation interval information as identified by accumulation interval identifier logic 180. This is indicated by block 268. The configuration information can include a wide variety of other information obtained in other ways as well. This is indicated by block 270.

Scheduling operation detector 183 then detects that a scheduling operation has been performed. This is indicated by block 272. For instance, it can detect that a new item has been placed on the calendar of user 120. It can also identify that automated scheduling assistant logic 150 has been invoked to insert a scheduling item (such as a meeting, a call, an appointment, etc.).

Criteria detection system 186 then identifies the time calculation criteria or request characteristics, corresponding to the scheduling operation that was detected. These criteria or characteristics will be used to identify the time value corresponding to the scheduling operation, which indicates the amount of time that user 120 has spent, or would have spent, in performing the tasks associated with the scheduling operation. Identifying the time calculation criteria/characteristics, is indicated by block 274. This can include a wide variety of different criteria or characteristics.

For instance, attendee identifier logic 198 can identify the identity of the various attendees, as indicated by block 276. It can identify the number of attendees, as indicated by block 278. Meeting location identifier logic 201 identifies a location where a meeting is scheduled. This is indicated by block 279. Attendee organization detector logic 202 can identify whether the attendees are part of the same organization or different organizations. This is indicated by block 280. Attendee location identifier logic 200 can identify whether the attendees are in the same or different time zones. This is indicated by block 282. It can also identify which time zones they are in order to determine whether the time zones are fairly lose together, or separated by a large amount. Criteria detection system 186 can also detect a number of communication turns (e-mails) that were performed by automated scheduling assistant logic 150 (or user 120) in order to perform the scheduling operation. This is indicated by block 284. Identifying the configuration criteria or request characteristics can be done in other ways as well, and this is indicated by block 286.

Time calculation logic 188 then calculates a time value corresponding to the scheduling operation that was performed. This is indicated by block 288, and it can be done, for instance, based on the calculation criteria or characteristics identified by criteria detection system 186, and as described above with respect to block 274. By way of example, pre-computed time data accessing logic 206 can access pre-computed values, given the identified criteria or request characteristics. Accessing the pre-computed values is indicated by block 290 in the flow diagram of FIG. 3. Saved time identifier logic 210 can access a model using the criteria or characteristics to identify a time value corresponding to the scheduling operation. This was discussed in more detail above, and it is indicated by block 292 in the flow diagram of FIG. 3. Historical data accessing logic 208 can also access historical data based on the criteria or characteristics of the scheduling operation. It can then compute the time associated with that scheduling operation based upon the historical data, given the criteria or characteristics. This was also discussed above, and is indicated by block 294. Calculating the time value corresponding to the scheduling operation can be done in a wide variety of other ways as well, and this is indicated by block 296.

Assistant invocation detector 184 then determines whether the scheduling operation was performed using the automated scheduling assistant logic 150. This is indicated by block 298 in the flow diagram of FIG. 3. This is so that time aggregation logic 190 can accumulate the time value in the proper category. For instance, if the scheduling operation was not performed using automated scheduling assistant logic 150, then lost time aggregation logic 216 aggregates the time value with the accumulated lost time value. This is indicated by block 300. Time block triggering logic 192 then intermittently surfaces the accumulated time lost value for user 120, as discussed above. This is indicated by block 302 in the flow diagram of FIG. 3.

However, if, at block 298, it is determined that assistant invocation detector 184 has indicated that the scheduling operation was performed using automated scheduling assistant logic 150, then saved time aggregation logic 214 aggregates the time value with a saved time accumulated value, as discussed above. This is indicated by block 304 in the flow diagram of FIG. 3.

At some point, time block triggering logic 192 detects a time block scheduling trigger. This is indicated by block 306. As discussed above, the trigger can be that the accumulated saved time value may reach a threshold accumulated time. This is indicated by block 308. It may also be that the accumulation interval has run. This is indicated by block 310. The time block scheduling trigger can be detected in a wide variety of other ways as well, and this is indicated by block 312.

User interaction logic 194 then generates a user interface display for surfacing the aggregated information to the user 120. This is indicated by block 314. As discussed above, it can display the aggregated time that was saved using automated scheduling assistant logic 150 for the most recent accumulation interval. This is indicated by block 316. It can do this in a wide variety of different ways, some of which were discussed above. It can also conduct a natural language e-mail discourse with user 120 to obtain directions on how to reserve time in the future based upon the accumulated saved time. This is indicated by block 318. This can include, for instance, asking the user how large of blocks the user wishes to schedule at a given time, how far in the future the user wishes to reserve the time, among other things.

The user interface display (whether it is part of an e-mail message or separate) can include user actuatable input mechanisms that the user can actuate in order to authorize reserving time in the future or to provide further direction, or to provide other inputs. This is indicated by block 320. The actuators can include drill actuators, which allow the user to drill into additional information about the saved time. The additional detail may indicate which particular scheduling operations the time was accumulated from, among other things. This is indicated by block 322. The user interface display can be surfaced in a wide variety of other ways as well, and this is indicated by block 324.

UI interaction detection logic 222 then detects user interaction with the surfaced user interface display. This is indicated by block 326. The interactions may indicate that the user is authorizing the reservation of time, in the future, based on the accumulated saved time. This is indicated by block 328. The user interactions may be indicative of a wide variety of other user inputs as well, and this is indicated by block 330.

Scheduling control signal generator logic 224 then generates scheduling control signals based upon the detected user interactions. This is indicated by block 332. Those control signals can be used to control search logic 228 to search for a block of free time so that the accumulated time can be reserved. This is indicated by block 324. They can be control signals that control the size of the reserved blocks as indicated by block 326. They can be control signals that control the scheduling system to schedule (or reserve) the blocks of time that are identified by search logic 228. This is indicated by block 328. The control signals can control calendar entry display generator logic 230 to generate a calendar display with visual indicia indicating the saved or reserved time blocks. This is indicated by block 330. A wide variety of other control signals can be generated as well. This is indicated by block 332.

The present control system greatly enhances the operation of the computing system. By automatically accumulating saved time and controlling the scheduling system, the network bandwidth and processing overhead associated with round trips between the user and the scheduling system, are reduced. The user simply needs to authorize the system to track saved time and reserve block time in the future and it is automatically done within the computing system, without any further roundtrips with the user. Thus, this saves network bandwidth and the associated processing overhead.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

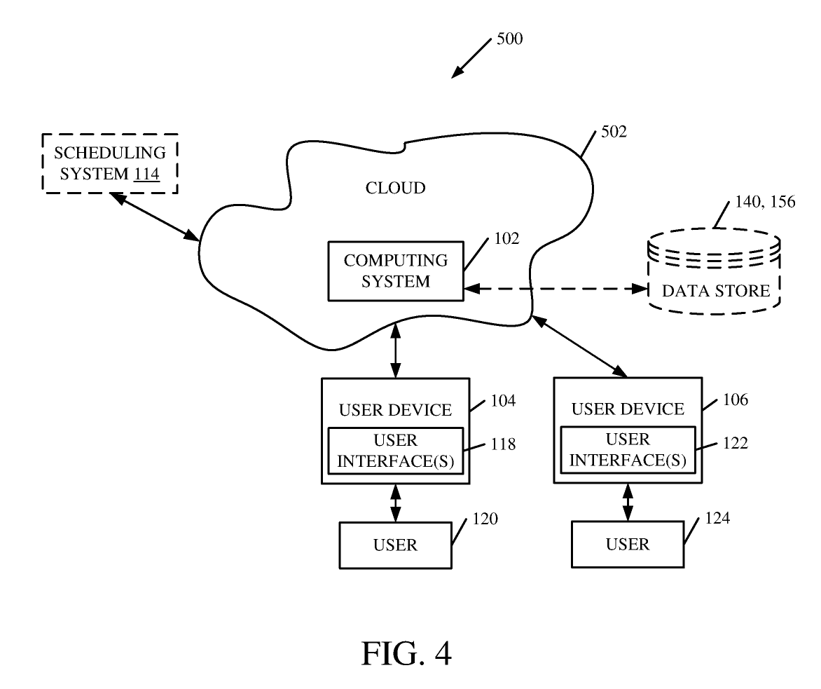

FIG. 4 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 4, some items are similar to those shown in FIG. 1 and they are similarly numbered. FIG. 4 specifically shows that computing system 102 can be located in cloud 502 (which can be public, private, or a combination where portions are public while others are private). Therefore, users 120 and 124 use user devices 104 and 106 to access those systems through cloud 502.

FIG. 4 also depicts another example of a cloud architecture. FIG. 4 shows that it is also contemplated that some elements of computing system 102 can be disposed in cloud 502 while others are not. By way of example, data stores 140, 156 can be disposed outside of cloud 502, and accessed through cloud 502. In another example, scheduling system 114 (or other items) can be outside of cloud 502. Regardless of where they are located, they can be accessed directly by devices 104-106, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

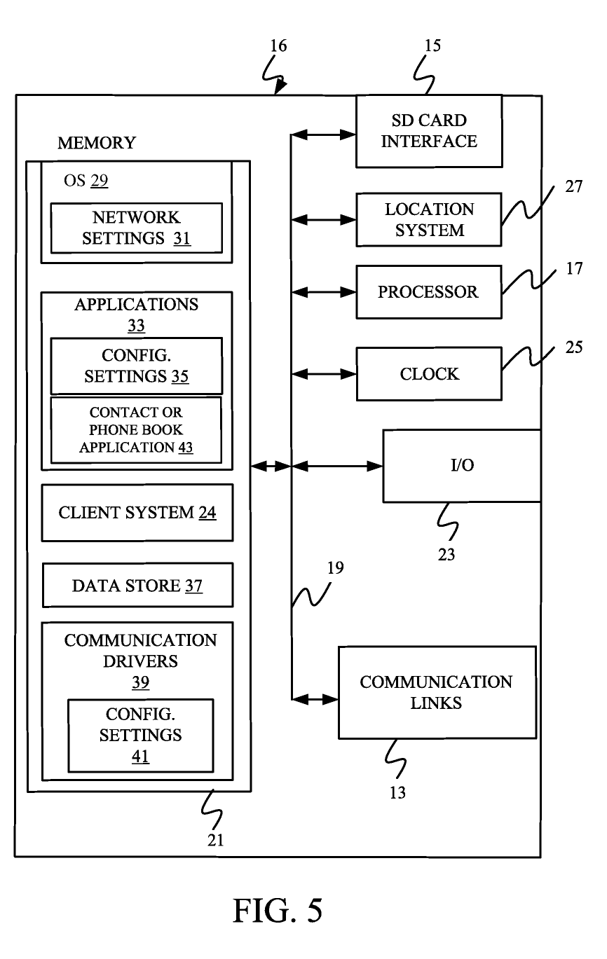

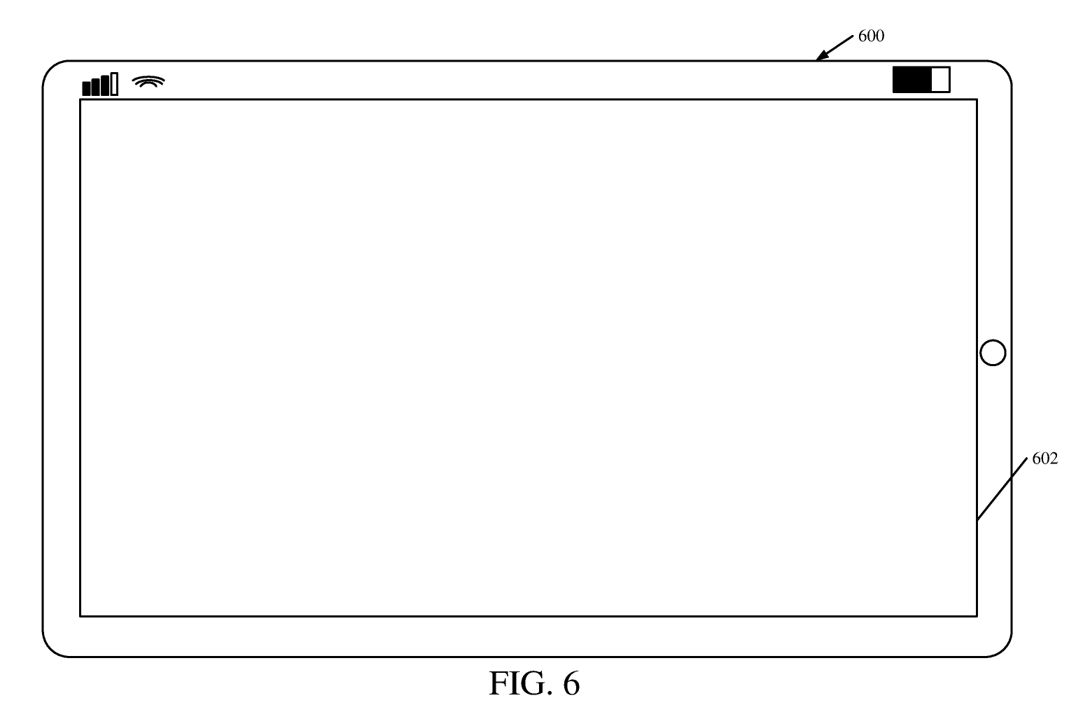

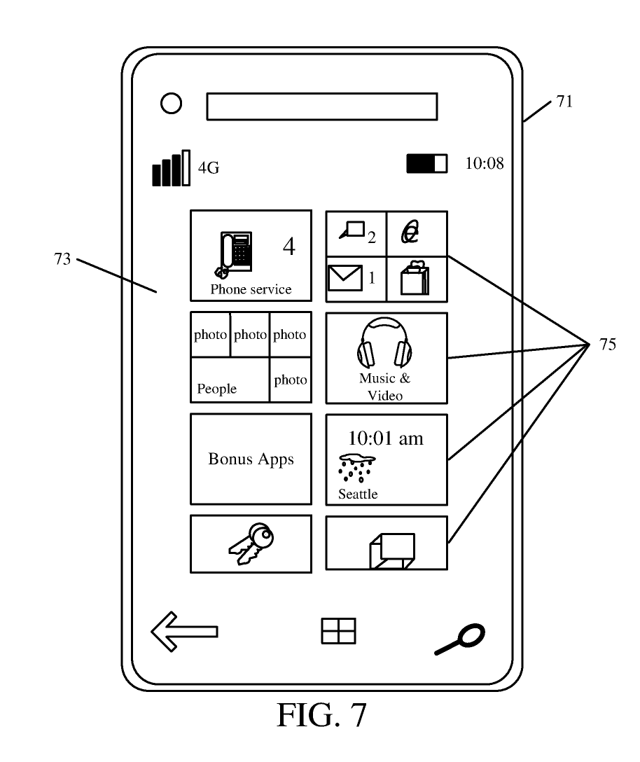

FIG. 5 is a simplified block diagram of one illustrative example of a handheld or mobile computing device that can be used as a user's or client's hand held device 16, in which the present system (or parts of it) can be deployed. FIGS. 6-7 are examples of handheld or mobile devices.

FIG. 5 provides a general block diagram of the components of a client device 16 that can run components computing system 102 or user devices 104-106 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from other FIGS.) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one example in which device 16 is a tablet computer 600. In FIG. 6, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 7 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

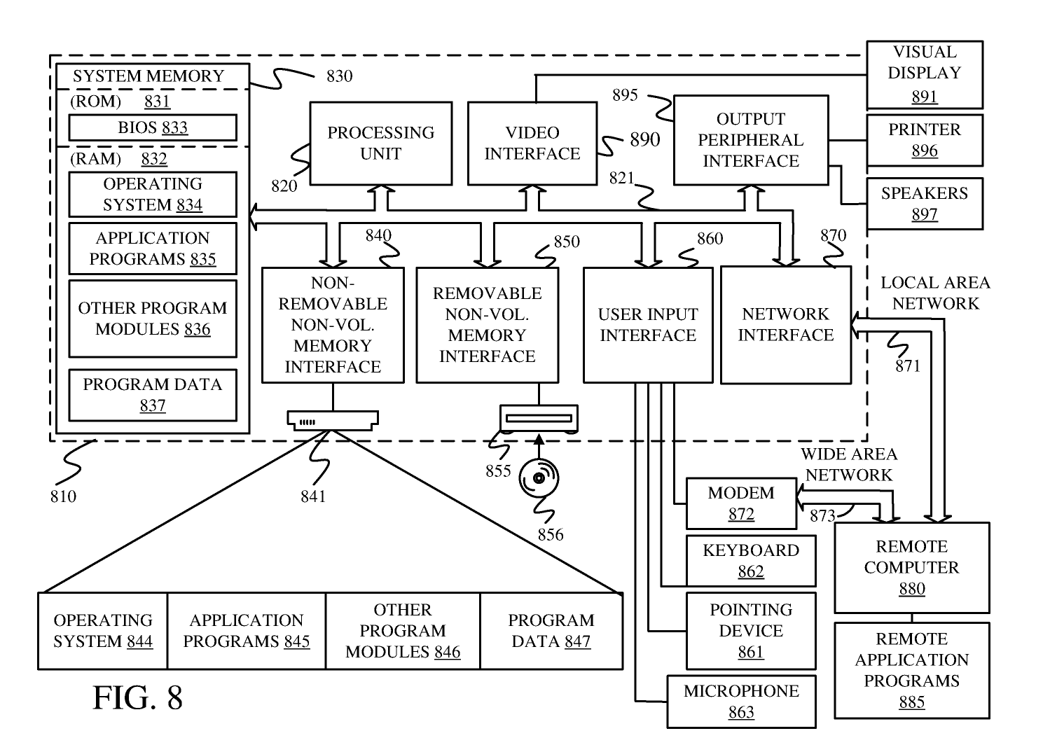

FIG. 8 is one example of a computing environment in which architecture 100, or parts of it, (for example) can be deployed. With reference to FIG. 8, an example system for implementing some embodiments includes a general-purpose computing device in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 8.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 8 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Example 1 is a computing system, comprising:

an assistant invocation detector that detects user invocation of automated scheduling assistant logic, that automatically executes user communication tasks in performing a scheduling operation, to perform a meeting scheduling operation to schedule a meeting of a group of attendees;

a criteria detection system that identifies characteristics of the meeting scheduling operation;

time calculation logic that determines a time value corresponding to the meeting scheduling operation based on the identified characteristics of the meeting scheduling operation, the time value being indicative of a time to manually perform the meeting scheduling operation;

time aggregation logic that aggregates the time value, with other time values generated by the time calculation logic and corresponding to other meeting scheduling operations, over an accumulation interval to obtain an accumulated time value; and

scheduling control signal generator logic that generates a scheduling control signal to control a scheduling system to reserve a block of time on a schedule of the user when the accumulated time value reaches an accumulated time threshold.

Example 2 is the computing system of any or all previous examples and further comprising:

user interaction logic configured to generate a representation of a user interface display with an accumulated time indicator identifying the accumulated time value and an indication that the accumulated time value resulted from invoking the automated scheduling assistant logic.

Example 3 is the computing system of any or all previous examples wherein the user interaction logic is configured to generate the representation of the user interface display with an actuator that is actuated by the user, the scheduling control signal generator logic being configured to generate the scheduling control signal to reserve the block of time in response to user actuation of the actuator.

Example 4 is the computing system of any or all previous examples wherein the criteria detection system comprises:

attendee identifier logic configured to identify an attendee characteristic indicative of a number of attendees invited to the meeting.

Example 5 is the computing system of any or all previous examples wherein the criteria detection system comprises:

attendee location identifier logic configured to identify a location characteristic indicative of a location of each of the attendees invited to the meeting.

Example 6 is the computing system of any or all previous examples wherein the criteria detection system comprises:

attendee organization detector logic configured to detect an organization characteristic indicative of whether the attendees belong to a same organization or a different organization.

Example 7 is the computing system of any or all previous examples wherein the time calculation logic comprises:

pre-computed time data accessing logic configured to identify the time value corresponding to the meeting scheduling operation by accessing a pre-computed time value based on the attendee characteristic, the location characteristic and the organization characteristic.

Example 8 is the computing system of any or all previous examples wherein the time calculation logic comprises:

saved time identifier logic configured to apply the attendee characteristic, the location characteristic and the organization characteristic to a saved time model to identify the time value corresponding to the meeting scheduling operation.

Example 9 is the computing system of any or all previous examples wherein the time calculation logic comprises:

historical data accessing logic configured to identify the time value corresponding to the meeting scheduling operation by accessing historical data indicative of a time value corresponding to the meeting scheduling operation based on the attendee characteristic, the location characteristic and the organization characteristic.

Example 10 is the computing system of any or all previous examples wherein the user interface display is part of an electronic mail (e-mail) message and wherein the actuator comprises a reply actuator on the user interface display.

Example 11 is the computing system of any or all previous examples and further comprising a scheduling operation detector configured to detect a scheduling operation performed by the user without invoking the automated scheduling assistant logic, and wherein the time aggregation logic comprises:

lost time aggregation logic configured to aggregate the time value, with other time values generated by the time calculation logic and corresponding to other meeting scheduling operations performed without invoking the automated scheduling assistant logic, over an accumulation interval, to obtain an accumulated lost time value, and wherein the user interaction logic is configured to generate a representation of a lost time user interface display displaying the accumulated lost time value.

Example 12 is a computer implemented method, comprising:

detecting user invocation of automated scheduling assistant logic, that automatically executes user communication tasks in performing a scheduling operation, to perform a meeting scheduling operation to schedule a meeting of a group of attendees;

identifying characteristics of the meeting scheduling operation;

determining a time value corresponding to the meeting scheduling operation based on the identified characteristics of the meeting scheduling operation, the time value being indicative of a time to manually perform the meeting scheduling operation;

aggregating the time value, with other time values generated and corresponding to other meeting scheduling operations, over an accumulation interval to obtain an accumulated time value; and

generating a scheduling control signal to control a scheduling system to reserve a block of time on a schedule of the user when the accumulated time value reaches an accumulated time threshold.

Example 13 is the computer implemented method of any or all previous examples and further comprising:

generating a representation of a user interface display with an accumulated time indicator identifying the accumulated time value and an indication that the accumulated time value resulted from invoking the automated scheduling assistant logic.

Example 14 is the computer implemented method of any or all previous examples wherein generating a representation of a user interface display comprises:

generating the representation of the user interface display with an actuator that is actuated by the user, and wherein scheduling the control signal comprises generating the scheduling control signal to reserve the block of time in response to user actuation of the actuator.

Example 15 is the computer implemented method of any or all previous examples wherein identifying characteristics of the meeting scheduling operation comprises:

detecting an attendee characteristic indicative of a number of attendees invited to the meeting; and

detecting an organization characteristic indicative of whether the automated scheduling assistant logic has access to a calendar for each of the attendees.

Example 16 is the computer implemented method of any or all previous examples wherein identifying characteristics of the meeting scheduling operation comprises:

identifying a location characteristic indicative of a time zone corresponding to each of the attendees invited to the meeting.

Example 17 is the computer implemented method of any or all previous examples determining a time value comprises:

identifying the time value corresponding to the meeting scheduling operation by accessing a pre-computed time value based on the attendee characteristic, the location characteristic and the organization characteristic.

Example 18 is the computer implemented method of any or all previous examples and further comprising:

detecting a scheduling operation performed by the user without invoking the automated scheduling assistant logic; and

aggregating time value corresponding to the scheduling operation performed by the user without invoking the automated scheduling assistant logic, with other time values generated by the time calculation logic and corresponding to other meeting scheduling operations performed without invoking the automated scheduling assistant logic, over an accumulation interval, to obtain an accumulated lost time value; and

generating a representation of a lost time user interface display displaying the accumulated lost time value.

Example 19 is a computing system, comprising:

an assistant invocation detector that detects user invocation of automated scheduling assistant logic, that automatically executes user communication tasks in performing a scheduling operation, to perform a meeting scheduling operation to schedule a meeting of a group of attendees;

a criteria detection system that identifies characteristics of the meeting scheduling operation;

time calculation logic that determines a time value corresponding to the meeting scheduling operation based on the identified characteristics of the meeting scheduling operation, the time value being indicative of a time to manually perform the meeting scheduling operation;

time aggregation logic that aggregates the time value, with other time values generated by the time calculation logic and corresponding to other meeting scheduling operations, over an accumulation interval to obtain an accumulated time value;

user interaction logic configured to generate a representation of a user interface display with an accumulated time indicator identifying the accumulated time value and an indication that the accumulated time value resulted from invoking the automated scheduling assistant logic and an actuator, actuatable to generate a reserve time signal; and

scheduling control signal generator logic that generates a scheduling control signal, based on the reserve time signal, to control a scheduling system to reserve a block of time on a schedule of the user when the accumulated time value reaches an accumulated time threshold.

Example 20 is the computing system of any or all previous examples wherein the user interface display is part of an electronic mail (e-mail) message and wherein the actuator comprises a reply actuator on the user interface display.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
an assistant invocation detector that detects user invocation of automated scheduling assistant logic, that automatically executes user communication tasks in performing a scheduling operation, to perform a meeting scheduling operation to schedule a meeting of a group of attendees;
a criteria detection system that identifies characteristics of the meeting scheduling operation;
time calculation logic that determines a time value corresponding to the meeting scheduling operation based on the identified characteristics of the meeting scheduling operation, the time value being indicative of a time to manually perform the meeting scheduling operation;
time aggregation logic that aggregates the time value, with other time values generated by the time calculation logic and corresponding to other meeting scheduling operations, over an accumulation interval to obtain an accumulated time value; and
scheduling control signal generator logic that generates a scheduling control signal to control a scheduling system to reserve a block of time on a schedule of the user when the accumulated time value reaches an accumulated time threshold.

2. The computing system of claim 1 and further comprising:
user interaction logic configured to generate a representation of a user interface display with an accumulated time indicator identifying the accumulated time value and an indication that the accumulated time value resulted from invoking the automated scheduling assistant logic.

3. The computing system of claim 2 wherein the user interaction logic is configured to generate the representation of the user interface display with an actuator that is actuated by the user, the scheduling control signal generator logic being configured to generate the scheduling control signal to reserve the block of time in response to user actuation of the actuator.

4. The computing system of claim 1 wherein the criteria detection system comprises:
attendee identifier logic configured to identify an attendee characteristic indicative of a number of attendees invited to the meeting.

5. The computing system of claim 4 wherein the criteria detection system comprises:
attendee location identifier logic configured to identify a location characteristic indicative of a location of each of the attendees invited to the meeting.

6. The computing system of claim 5 wherein the criteria detection system comprises:
attendee organization detector logic configured to detect an organization characteristic indicative of whether the attendees belong to a same organization or a different organization.

7. The computing system of claim 6 wherein the time calculation logic comprises:
pre-computed time data accessing logic configured to identify the time value corresponding to the meeting scheduling operation by accessing a pre-computed time value based on the attendee characteristic, the location characteristic and the organization characteristic.

8. The computing system of claim 6 wherein the time calculation logic comprises:
saved time identifier logic configured to apply the attendee characteristic, the location characteristic and the organization characteristic to a saved time model to identify the time value corresponding to the meeting scheduling operation.

9. The computing system of claim 6 wherein the time calculation logic comprises:
historical data accessing logic configured to identify the time value corresponding to the meeting scheduling operation by accessing historical data indicative of a time value corresponding to the meeting scheduling operation based on the attendee characteristic, the location characteristic and the organization characteristic.

10. The computing system of claim 3 wherein the user interface display is part of an electronic mail (e-mail) message and wherein the actuator comprises a reply actuator on the user interface display.

11. The computing system of claim 2 and further comprising a scheduling operation detector configured to detect a scheduling operation performed by the user without invoking the automated scheduling assistant logic, and wherein the time aggregation logic comprises:
lost time aggregation logic configured to aggregate the time value, with other time values generated by the time calculation logic and corresponding to other meeting scheduling operations performed without invoking the automated scheduling assistant logic, over an accumulation interval, to obtain an accumulated lost time value, and wherein the user interaction logic is configured to generate a representation of a lost time user interface display displaying the accumulated lost time value.

12. A computer implemented method, comprising:
detecting user invocation of automated scheduling assistant logic, that automatically executes user communication tasks in performing a scheduling operation, to perform a meeting scheduling operation to schedule a meeting of a group of attendees;
identifying characteristics of the meeting scheduling operation;
determining a time value corresponding to the meeting scheduling operation based on the identified characteristics of the meeting scheduling operation, the time value being indicative of a time to manually perform the meeting scheduling operation;
aggregating the time value, with other time values generated and corresponding to other meeting scheduling operations, over an accumulation interval to obtain an accumulated time value; and
generating a scheduling control signal to control a scheduling system to reserve a block of time on a schedule of the user when the accumulated time value reaches an accumulated time threshold.

13. The computer implemented method of claim 12 and further comprising:
generating a representation of a user interface display with an accumulated time indicator identifying the accumulated time value and an indication that the accumulated time value resulted from invoking the automated scheduling assistant logic.

14. The computer implemented method of claim 13 wherein generating a representation of a user interface display comprises:
generating the representation of the user interface display with an actuator that is actuated by the user, and wherein scheduling the control signal comprises generating the scheduling control signal to reserve the block of time in response to user actuation of the actuator.

15. The computer implemented method of claim 12 wherein identifying characteristics of the meeting scheduling operation comprises:
detecting an attendee characteristic indicative of a number of attendees invited to the meeting; and
detecting an organization characteristic indicative of whether the automated scheduling assistant logic has access to a calendar for each of the attendees.

16. The computer implemented method of claim 15 wherein identifying characteristics of the meeting scheduling operation comprises:
identifying a location characteristic indicative of a time zone corresponding to each of the attendees invited to the meeting.

17. The computer implemented method of claim 16 wherein identifying characteristics of the meeting scheduling operation comprises:
identifying a location characteristic indicative of where the meeting is located.

18. The computer implemented method of claim 17 determining a time value comprises:
identifying the time value corresponding to the meeting scheduling operation by accessing a pre-computed time value based on the attendee characteristic, the location characteristic and the organization characteristic.

19. The computer implemented method of claim 13 and further comprising:
detecting a scheduling operation performed by the user without invoking the automated scheduling assistant logic; and
aggregating time value corresponding to the scheduling operation performed by the user without invoking the automated scheduling assistant logic, with other time values generated by the time calculation logic and corresponding to other meeting scheduling operations performed without invoking the automated scheduling assistant logic, over an accumulation interval, to obtain an accumulated lost time value; and
generating a representation of a lost time user interface display displaying the accumulated lost time value.

20. A computing system, comprising:
an assistant invocation detector that detects user invocation of automated scheduling assistant logic, that automatically executes user communication tasks in performing a scheduling operation, to perform a meeting scheduling operation to schedule a meeting of a group of attendees;
a criteria detection system that identifies characteristics of the meeting scheduling operation;
time calculation logic that determines a time value corresponding to the meeting scheduling operation based on the identified characteristics of the meeting scheduling operation, the time value being indicative of a time to manually perform the meeting scheduling operation;
time aggregation logic that aggregates the time value, with other time values generated by the time calculation logic and corresponding to other meeting scheduling operations, over an accumulation interval to obtain an accumulated time value;
user interaction logic configured to generate a representation of a user interface display with an accumulated time indicator identifying the accumulated time value and an indication that the accumulated time value resulted from invoking the automated scheduling assistant logic and an actuator, actuatable to generate a reserve time signal; and
scheduling control signal generator logic that generates a scheduling control signal, based on the reserve time signal, to control a scheduling system to reserve a block of time on a schedule of the user when the accumulated time value reaches an accumulated time threshold.
